(19) United States
(12) Patent Application Publication
(10) Pub. No.: US 2002/0104424 A1
(43) Pub. Date: Aug. 8, 2002

(54) Modular stringed instrument system

(76) Inventor: Michael Sebastian Spalt, Los Angeles, CA (US)

Correspondence Address: MICHAEL S. SPALT, 1316 MANZANITA ST., LOS ANGELES, CA, 90027, US

(21) Appl. No.: 10/051,854

(22) Filed: Jan. 16, 2002

Related U.S. Application Data
(60) Provisional application No. 60/262,249, filed on Jan. 17, 2001.

(51) Int. Cl. G10D 3/00

(52) U.S. Cl. 84/291

(57) ABSTRACT

A stringed instrument system is disclosed, which consists of an array of modular parts, which can be assembled in a variety of ways, enabling the user to configure the instrument according to his needs and desires. Core of the system is a mounting platform which offers means of attachment for a neck, a bridge, an electronic pickup system and extensions made of wood or some other appropriate material intended to facilitate holding or resting the instrument against the player's body, designed to be adjusted accordingly, and which can be routed to accept various configurations of controls for manipulation of the signal. A number of individual designs can be combined in a “plug and play” fashion according to the tastes and requirements of the player.

This application claims benefit of the filling date Jan. 17, 2001 of the Provisional Patent Application Ser. No. 60/262,249:

### BACKGROUND OF THE INVENTION

1. Field of Invention

This invention relates to improvements in the construction and design of electrical stringed musical instruments, particularly guitars and basses.

2. Description of the Prior Art

Conventional electric stringed instruments consist of a solid body with a neck attached either permanently or by means of screws. The body is routed for the pickups and ancillary electronic controls and connectors. On the body a bridge is mounted either in a fixed manner or by means of some pivoting device for achieving a “tremolo” effect. The strings are attached to this bridge by various means. The other end of the strings is attached by means of tuners to the headstock of the neck. This design offers limited flexibility of tonal characteristics and handling. Any alterations require complex procedures, which can also result in a diminished value of the instrument. Several designs have been disclosed which attempt to improve on the conventional design by offering modular components, which can be exchanged, or to facilitate transportation by collapsing the instrument. Most of these designs have not addressed the ergonomic requirements of musicians and have been hampered by a limited choice of components and options. There is a large variety of standardized components like pickups and bridges available on the market, which are accessible through this design. Most prior art describing modular designs requires proprietary elements which are not readily accessible and which are not familiar to the working musician. This invention is designed with a view to allowing the use of standardized parts.

The instrument described in this application actually consists of a system of parts designed to be purchased separately and which can be combined freely and quickly to create the desired instrument by use of a few simple tools such as hex-key and screwdriver. In addition some of these parts are movable and adjustable to allow for even greater flexibility. Additionally this system enables the choice of different woods for feel, look and tone. Each element of the instrument has been designed to allow for the most comprehensive application of the modular design principle while keeping in mind and improving on playability, durability and tonal characteristics.

Various playing styles, physical characteristics and preferences of players require different ergonomic approaches to the body-instrument interface. This design offers a range of tailored pieces, which can be assembled to create an instrument fulfilling all these requirements.

### SUMMARY OF THE INVENTION

A central platform designed to allow attachment of the various component parts in this preferred embodiment consists of aluminum. The attachment of component members of the system is effected by screws or similar fastening devices, which can be readily separated while offering a stable and durable connection. The metal plate provides for the “ground” leg of the circuitry involved and acts as a shield against unwanted electronic interference. Where such interference is not a problem or where there is danger of a shock hazard due to varying polarities (between microphones and amplifiers) the ground can be severed. The metal plate also offers sonic advantages, particularly in the transmission of sound vibrations in the bass range, resulting in the instrument having a clearer, more articulated tone than conventional designs.

Various necks can be attached to the front end of the platform. Tonal characteristics of an instrument are determined by the materials used and different wood types, different construction methods or the use of other materials such as graphite or fiberglass will yield a different sound. Some players, particularly bass players, prefer “fretless” necks. To enable the musician access to all these possibilities, a variety of neck materials and designs are made available. Variable numbers of strings may be used on guitars or basses and this is also accommodated by different widths of the fretboard and number of slots in the nut. All necks are provided with means of attachment aligned to fit the mounting platform.

The neck ends in an extension near the nut on which the headstock plate is mounted. This plate provides for the attachment of the headstock proper to the neck and consists in this preferred embodiment of aluminum.

A need exists for the free exchange of the headstock since left-handed players require an “upside down design”. There is also a difference in string tension and consequently the sound and playing characteristics of said string by varying the length of the string when it is tuned to pitch. The ability of mounting different headstock configurations allowing for variations in the number of strings, the length of strings, and the orientation and type of tuning heads, is an important element of this design. The headstock is also made of aluminum, which allows for small size, lightweight and improved stability vs. a traditional wooden one. So-called “headless” designs are also available.

At the rear end of the mounting platform, means of attachment exist for the fastening of a bridge or bridge system. Different designs of available bridges, also bridges which allow for different numbers of strings, “through the body”-style stringing or, if preferred, the mounting of tuners to the bridge (so-called “headless” tuning systems) are accommodated by the exchange of a bridge interface plate which allows variations in footprints and screw patterns. Some pickup systems are available which are incorporated in the bridge and these can also be accommodated quickly and efficiently. In contrast a conventional instrument would require extensive modification.

The upper and lower edge of the platform is configured to allow attachment of body parts to the instrument. These are shaped ergonomically with a view towards lightweight and for maximum bodily comfort and balance of the instrument. In addition, the use of small, irregular shaped pieces of wood, which would otherwise be designated as scrap, allows for conservation of wood resources.

The upper body part, which in this case consists of a movable adjustable combination hand-, arm- and thumb-rest, is attached by means of a pivoting point, which allows for the fine-tuning of the player's hand position. Different aesthetic and ergonomic requirements can be accommodated by variously shaped parts, which can also be made from different materials and colors, thereby offering a wide variety of choices. Players of differing physical stature will have access to parts shaped for their greatest comfort. The part also has incorporated the means to attach a strap to enable the musician to play the instrument while standing.

The lower body part incorporates a knee rest, to allow playing in the sitting position and allows for the attachment of electronic controls, power supplies for the pickups and/or preamps and for a jack to connect the instrument to an amplifier or other electronic device. The rear part of the part is hollow and a modular control cover with the controls etc. attached, can be dropped in and secured by prefitted screws. According to the musician's needs different modules can be acquired, all fitted with modular jacks allowing for quick connection to a variety of pickups or to expand or vary the electronic tone shaping capabilities of the instrument. Some players prefer “passive” pickup systems, others “active” ones which require a battery, others a combination of both, either with preamp or without. There are also a number of variables in the layout of the controls, which may be desired. The number of knobs and switches required can vary considerably. This necessitates the ability to configure all these options in combination with each other in a simple and efficient manner. All parts in this design are interconnected by plugs, rather than soldered and therefore can be exchanged with a minimum of effort. Various cover plates allow for different control patterns. The part also incorporates means of attachment for a strap.

The pickups are mounted to the platform directly and connected to the controls by means of plugs. The platform is drilled and tapped to accommodate all mounting screw patterns of pickups commonly available. No routing, disassembling or soldering is necessary to exchange the pickups. In addition an option for a movable pickup is offered, which consists of a pickup sled on which the pickup is mounted and which can be movably fastened in the preferred spot to achieve the desired tonal characteristics. Moving the pickup closer to the bridge will brighten the sound, while moving it towards the neck will enhance the bass tones. Slanting the pickup in different ways will also influence its sound. This allows for a shaping of tone which is quite different from the electronic kind and which can be quickly achieved by loosening the thumbscrew, moving the sled and tightening it again.

In addition there are options for attachments to the platform which are designed for specific purposes, such as an adjustable “slapping plate” to facilitate a common bass playing technique, a backpad made of wood or similar material, mounted on the rear of the upper horn of the platform, to insulate the player's body against the cold of the metal platform and to allow for a comfortable resting position against the player's torso or belly. Some specialized playing techniques also require a separate thumbrest, which can be movably attached to the front of the upper horn of the platform.

The modular concept has been explored to some extent in the prior art. This invention differs in that the modular properties have been extended to every facet of the instrument and have been designed with a view to ease of construction, practicability and, most importantly, the requirements of a diverse community of working musicians in mind. The intention to make this instrument available as a system which can be acquired in individual parts to be chosen from a wide variety of alternatives and assembled even by a person unskilled as luthier sets this instrument (system) apart.

The ergonomic interface between body and instrument, which in this particular family of instruments is a vital part of the musical process, allows for greater comfort and closer contact with the instrument. The exchangeability of parts allows for the tailoring of the instrument to individual needs. In addition the construction of the instrument ensures superior sound characteristics and greater stability along with greater ease of service.

The reversible headstock, the bridge-body interface plate, the curved captive neck joint, are new features peculiar to this invention which offer advantages not previously available.

### DESCRIPTION OF THE DRAWINGS

Page 1

FIG. 1 shows a complete view of the assembled instrument, illustrating the mounting plate (1) to which the neck (2) and the lower body part (3) and the upper body part (4) are fastened with screws or bolts. The electronics compartment (5) is housed in the lower body part (3). Attached to the neck (2) is the headstock plate (6) which provides for the attachment of the headstock (7) proper to the neck (2). The tuners (8)(in this case a B 4-string configuration). Pickups (9) are mounted directly to the plate. The bridge (10) is mounted by means of an interface plate. (11) Strap button on the upper horn.

FIG. 2 shows a partial view of the back, of the plate

The neck (2) bolts directly to the plate. On the upper horn there is a backpad (12). The rear of the lower body extension incorporates the output jack (13).

Page 2

FIG. 3 shows the mounting plate and lower body extension.

The lower body extension (3) is connected to the mounting plate (1) by means of screws (a) which fit into inserts (b) provided in the body part. The electronics compartment (14) with mounting inserts for the modular control cover.

FIG. 4 shows a control module.

The control cover (5) with mounted potentiometers and connecting wires with plugs (15).

FIG. 5 shows the attachment of the upper body part.

The mounting plate (1) is provided with a circular extension with a pivot point (17) and a indexing slot (16). By means of pivot bolt (d) and fastening screw (c) which passes through the indexing slot, the upper body part (4) can be rotated against the friction plate (18) and fixed in the desired position.

FIG. 6 shows the bridge assembly.

The desired bridge (10) is attached by means of the appropriate interface plate (19) to the mounting plate (1). The screws (g) connect the bridge to the interface plate which in turn is connected to the mounting plate with the screws (f). The pickup (9) is connected to the mounting plate by means of screws (e).

Page 3

FIG. 7 shows the headstock assembly.

The headstock plate (6) attaches to the neck (2) in front of the nut (20) by means of bolts or screws. The headstock (7) (in this case a 4-string model) is mounted to the plate with the bolts (i) and can be reversed if needed. The tuners (8) mount to the headstock by means of the nuts (h).

FIG. 8 shows the pickup sled assembly.

The pickup (9) is mounted to the sled (21) by means of screws (J). This assembly is movably mounted to the plate (1) by means of a thumb screw (22) passing through the slot in the mounting plate.

FIG. 9 shows a cutaway of the assembly.

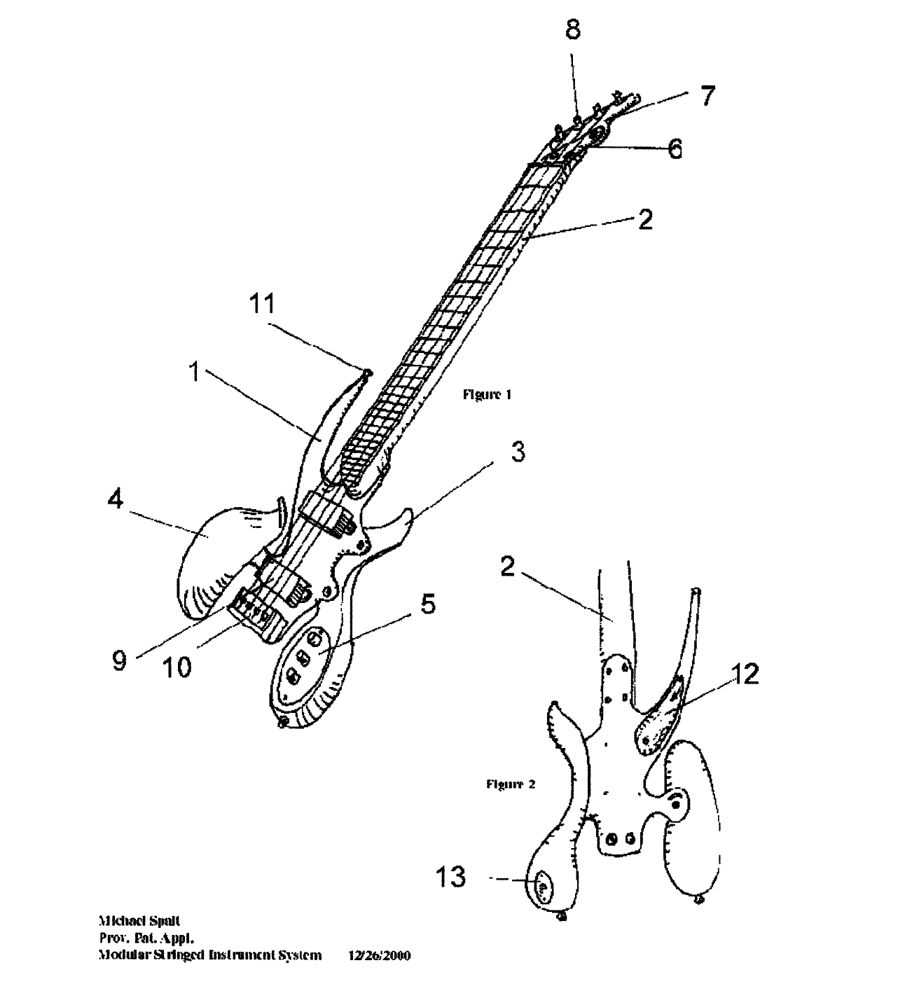

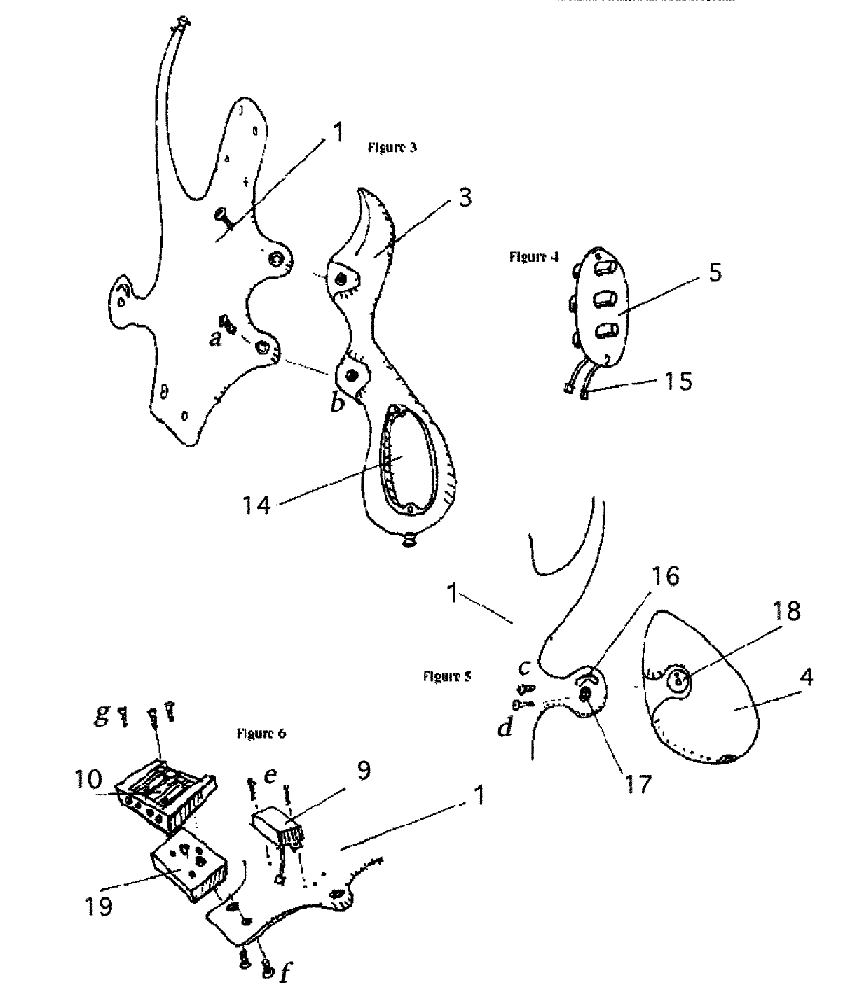

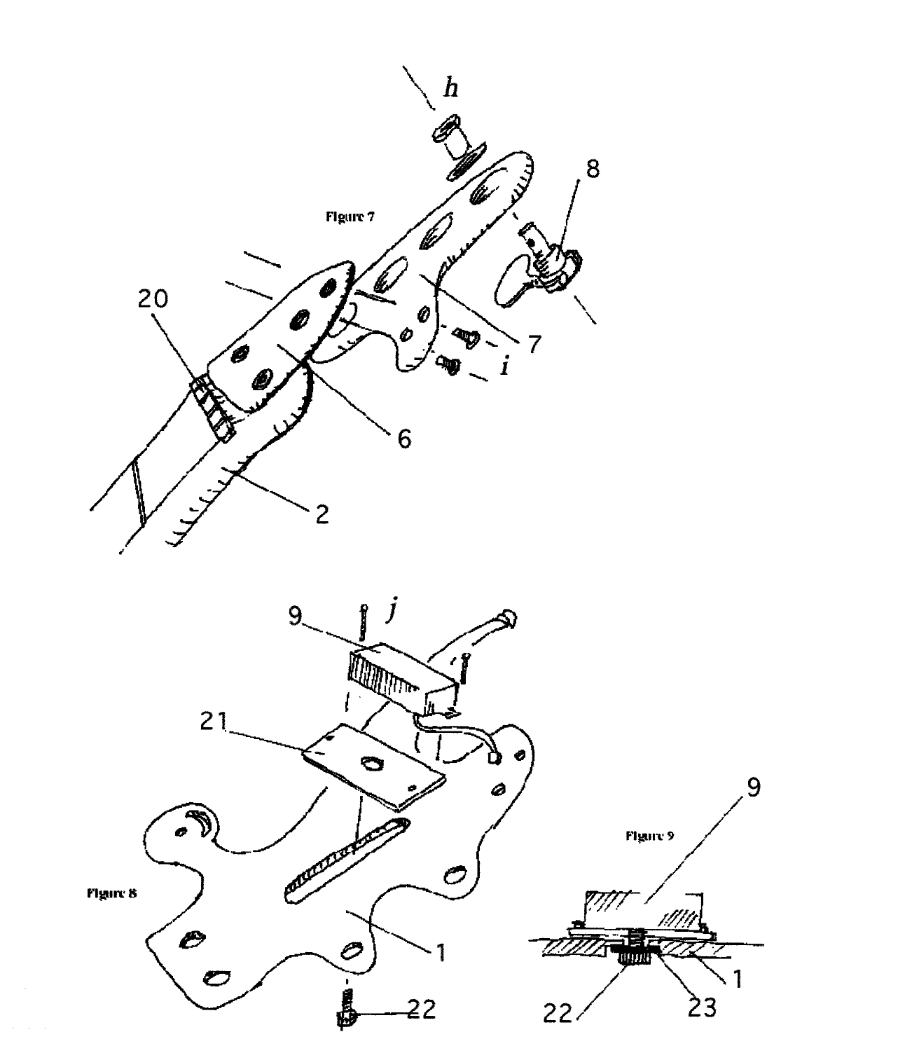

The pickup (9) on the sled is mounted to the plate (1) by means of the thumbscrew (22) and friction washer (23).

I claim:

1. A detachable reversible headstock allowing for the mounting of a plurality of tuners in both left- and right hand mode.

2. An exchange able bridge plate, movably fastened to the body plate, allowing the installation of a wide variety of bridges with differing footprints and bolt patterns to the instrument.

3. A pickup sled, movably fastened to the body plate, designed to accept different designs of pickups and positioning relative to the bridge or heel of the neck.

4. A modular instrument comprised of exchangeable parts movably fastened to each other as defined in claim 1 and 3, to allow for repositioning and for attachment of elements such as bridges and pickups.
